(19) United States
(12) Patent Application Publication
(10) Pub. No.: US 2006/0274405 A1
(43) Pub. Date: Dec. 7, 2006

(54) Ultraviolet curing process for low k dielectric films

(76) Inventors: Carlo Waldfried, Middleton, MA (US); Orlando Escorcia, Falls Church, VA (US); Gerald Beyer, Leuven (DE); Francesca Iacopi, Leuven (DE)

Correspondence Address: CANTOR COLBURN, LLP, 55 GRIFFIN ROAD SOUTH, BLOOMFIELD, CT, 06002, US

(21) Appl. No.: 11/446,052

(22) Filed: Jun. 2, 2006

Related U.S. Application Data
(60) Provisional application No. 60/687,576, filed on Jun. 3, 2005.

(51) Int. Cl. F21V 9/04

(52) U.S. Cl. 359/359

(57) ABSTRACT

Processes for forming a low k dielectric material onto a surface of a substrate comprises depositing the low k dielectric material onto the surface; and exposing the low k dielectric material to ultraviolet radiation for a period of time and intensity effective to increase a mechanical property of the low k dielectric material, wherein the mechanical property is significantly improved compared to a corresponding mechanical property of the low k dielectric material free from exposure to the ultraviolet radiation, or the corresponding mechanical property of the low k dielectric material that is furnace cured, or the corresponding mechanical property of the low k dielectric material that is exposed to excessive activating energy prior to ultraviolet radiation exposure, wherein excessive activating energy comprises an excessive hotplate bake sequence, a furnace cure, an annealing cure, a multi-temperature cure process or plasma treatment prior to the ultraviolet radiation.

### CROSS REFERENCE TO RELATED APPLICATIONS

The present application claims the benefit of U.S. Provisional Application No. 60/687,576 filed on Jun. 3, 2005, the contents of which are incorporated by reference in its entirety.

### BACKGROUND

The present disclosure generally relates to dielectric films in semiconductor devices, and more particularly, to ultraviolet (UV) curing processes for low k dielectric films.

In the field of advanced semiconductor fabrication, dielectrics with low k values are required for future generations of integrated circuits having design rules of less than or equal to 90 nanometers (nm) so as to reduce overall capacitance crosstalk. The term “low k dielectric” generally refers to materials having a dielectric constant less than a silicon oxide, e.g., SiO₂. That is, a dielectric constant generally less than about 3.9. More typically, for the advanced design rules, the dielectric constants of the low k dielectric materials are selected to be less than 3.0, and oftentimes less than 2.5. The dielectric films are generally deposited or formed using a spin-on process or by using a chemical vapor deposition (CVD) process.

To achieve low dielectric constants, one can either use a material that possesses a low dielectric constant, and/or introduce porosity into the film. Increasing porosity effectively lowers the dielectric constant since the dielectric constant of air is 1.0. However, increasing the porosity of the film directly affects the thermal and mechanical properties, which are needed to withstand the stresses of back end of line processing (BEOL). For example, after the deposition of the low k film either by the spin-on process or CVD process, a bake (spin-on materials) and subsequently cure process is generally performed. The bake process generally comprises several heating steps performed on a (single wafer) hotplate directly after the deposition process. This bake process is used to outgas residual components and solvents and makes the low k film more solid for further processing. A curing process is then applied, most commonly performed in a furnace. The conventional bake and cure processes undesirably subject the wafer to an elevated temperature for an extended period of time (e.g., in excess of one hour to several hours and at a temperature in greater than about 300° C.). These temperatures can exceed the allowable thermals budgets manufacturers are required to meet. In addition to affecting the thermal and mechanical properties, the so-cured dielectric materials have relatively poor wet etching resistance, an area of concern where improvement is generally desired.

In addition, some low k materials may be provided with a catalyst or other chemical reactant that may be activated by energy, which may be provided by exposure to thermal or other energy sources, including but not limited to high multi-temperature baking, a furnace curing, an anneal curing, plasma exposure, electron beam exposure, chemical exposure or a multi-temperature cure process prior to the ultraviolet radiation in order to induce the curing process.

U.S. Pat. No. 6,756,085 by Waldfried et al. describes the use of ultra-violet (UV) radiation for curing a low k dielectric material. This UV curing is typically performed after the conventional bake process on a hotplate which subjected the low k film already towards rather long heating periods and rather high temperatures resulting in activation of the catalyst or other chemical reactant and unwanted thermal budgets.

Accordingly, there remains a continual need for improvements in the integration of low k dielectric materials into the manufacturing process of the integrated circuit. Desirably, these improvements should improve the mechanical properties of the dielectric material without deleteriously affecting the dielectric constant. Still further, these improvements should not negatively impact the thermal budgets required for the particular technology node.

### BRIEF SUMMARY

Disclosed herein are processes for forming a low k dielectric material coated onto a surface of a substrate. In one embodiment, the process for forming a low k dielectric material coated onto a surface of a substrate comprises depositing the low k dielectric material onto the surface, wherein the low k material comprises a catalyst and/or chemical reactant; and exposing the low k dielectric material to ultraviolet radiation for a period of time and intensity effective to increase a mechanical property of the low k dielectric material, wherein the mechanical property increases relative to a corresponding mechanical property of the low k dielectric material free from exposure to the ultraviolet radiation, or the corresponding mechanical property of the low k dielectric material that is furnace cured, or the corresponding mechanical property of the low k dielectric material that is exposed to excessive activating energy prior to ultraviolet radiation exposure.

With respect to exposing the low k dielectric material to ultraviolet radiation, it is intended that the process avoids exposure of the low k material to excessive activation energy prior to exposure to ultraviolet radiation, such that any catalyst or chemical reactant residing in the low k material remains active prior to the UV radiation exposure. Indeed, in one embodiment, it is contemplated that a catalyst or chemical reactant may be injected by gas injection, spin-on, or otherwise subsequent to exposure of the low k dielectric to any activation energy, but prior to, or simultaneously with, exposure of the low k material to UV radiation, such that the catalyst or chemical reactant will be present during UV radiation exposure.

In another embodiment, the process for forming the low k dielectric material comprises depositing the low k dielectric material onto the surface, wherein the low k material comprises a catalyst and/or chemical reactant; and exposing the low k dielectric material to ultraviolet radiation, wherein the steps of depositing and exposing are effective to provide a crosslinking efficiency greater than 97% and form the low k dielectric material.

In yet another embodiment, the process comprises depositing the low k dielectric material onto the surface, wherein the low k material comprises a catalyst and/or chemical reactant; and exposing the low k dielectric material to ultraviolet radiation for a period of time and intensity effective to increase a elastic modulus property of the low k dielectric material, wherein the elastic modulus property is significantly improved compared to a corresponding elastic modulus property of the low k dielectric material free from exposure to the ultraviolet radiation, or the corresponding elastic modulus property of the low k dielectric material that is furnace cured, or the corresponding elastic modulus property of the low k dielectric material that is exposed to excessive activating energy prior to ultraviolet radiation exposure, wherein excessive activating energy comprises a furnace cure, an annealing cure, or a multi-temperature cure process prior to the ultraviolet radiation. The process avoids exposure of the low k material to excessive activation energy prior to exposure to ultraviolet radiation, such that the presence of any catalyst or chemical reactant residing in the low k material remains active prior to exposure of the low k material to UV radiation to enhance the cross-liking thereof. Alternatively, a catalyst or chemical reactant may be introduced, by gas injection, spin-on, or otherwise, subsequent to exposure of the low k dielectric to any activation energy, but prior to, or simultaneously with, exposure of the low k material to UV radiation.

In yet another embodiment, the process comprises depositing the low k dielectric material onto the surface, wherein the low k material comprises a catalyst and/or chemical reactant; and exposing the low k dielectric material to ultraviolet radiation for a period of time and intensity effective to increase a hardness property of the low k dielectric material, wherein the hardness property is significantly improved compared to a corresponding hardness property of the low k dielectric material free from exposure to the ultraviolet radiation, or the corresponding hardness property of the low k dielectric material that is furnace cured, or the corresponding hardness property of the low k dielectric material that is exposed to excessive activating energy prior to ultraviolet radiation exposure, wherein excessive activating energy comprises a furnace cure, an annealing cure, or a multi-temperature cure process prior to the ultraviolet radiation. The process avoids exposure of the low k material to excessive activation energy prior to exposure to ultraviolet radiation, such that any catalyst or chemical reactant residing in the low k material remains active prior to the UV radiation exposure. By the present invention, it has been found that such catalyst or chemical reactant may be undesirably activated prior to the UV radiation exposure such that it is desirable to avoid exposure of the low k material to excessive activation energy prior to exposure to ultraviolet radiation. Thus, any catalyst or chemical reactant residing in the low k material remains active prior to the UV radiation exposure. Alternatively, catalysts or chemical reactants may be introduced subsequent to exposure of the low k dielectric to any activation energy, but prior to, or simultaneously with, exposure of the low k material to UV radiation.

In still another embodiment, the process for forming a cured low k dielectric material coated on a substrate comprises depositing the low k dielectric material onto the surface, wherein the low k material comprises a catalyst and/or chemical reactant; avoiding exposure of the low k dielectric material to excessive activating energy from a furnace cure, an annealing cure, or a multi-temperature cure process; and exposing the low k dielectric material to ultraviolet radiation for a period of time and intensity effective to cure the low k dielectric material.

The processes described herein are suitable for commonly utilized spin-on low k materials and CVD deposited low k materials. Special attention is also given in an embodiment towards new developed low k materials based on silica zeolites. U.S. Pat. No. 6,573,131 describes the use of silica zeolite low k dielectric thin films as dielectric in semiconductor devices. This new class of low k materials or silica zeolite films, e.g. nano-clustered silica (NCS), are deposited by spin-coating a material comprising a silica source and a catalyst (also referred to as commander or zeolite forming structure directing agent) in an appropriate solvent onto a substrate. A process for forming these zeolite low k materials comprising a single bake step (up to approximately 150° C.) performed directly after the deposition process and prior to the UV cure process, which removes most of the solvent but keeps most of the catalyst present in the low k film. The presence of the catalyst during the subsequent UV cure process results in enhanced cross-linking efficiency (also referred to as enhanced structuring) of the low k material, thereby yielding desirable enhanced mechanical property, enhanced hardness property, and/or enhanced elastic modulus property.

The above described and other features are exemplified by the following figures and detailed description.

### BRIEF DESCRIPTION OF THE DRAWINGS

Referring now to the figures, which are exemplary embodiments and wherein like elements are numbered alike:

FIG. 1 graphically illustrates crosslinking efficiency as a function of thermal exposure for a methylsilsesquioxane film, wherein the thermal exposure was prior to ultraviolet exposure.

FIG. 2 illustrates the network of a NCS material before and after UV-cure in accordance with one embodiment.

FIG. 3 graphically illustrates the phase velocity as a function of the wave vector for a NCS low k material after a furnace cure, a conventional UV cure performed after a full bake sequence, a UV cure performed after a partial bake sequence (comprising a first bake step at 150° C. and a second bake step at 250° C.) and a UV cure performed after a partial bake (comprising one bake step at 150° C.). The resulting elastic modulus is also shown.

FIG. 4 graphically illustrates the elastic modulus of a NCS low k material after a furnace cure, a conventional UV cure performed after full bake sequence, a UV cure performed after a partial bake sequence (comprising a first bake step at 150° C. and a second bake step at 250° C.) and a UV cure performed after a partial bake (comprising one bake step at 150° C.).

FIG. 5 shows the FTIR spectrum of a NCS low k material after a partial bake process comprising a first bake step at 150° C. and a second bake step at 250° C. and the FTIR spectrum of the same NCS low k material after a partial bake process comprising a single bake step at 150° C.

### DETAILED DESCRIPTION

The present disclosure is generally directed to a UV curing process for low k dielectric materials. The process generally includes depositing the low k dielectric material by any means onto a suitable substrate and curing the low k dielectric by exposure to ultraviolet radiation having one or more wavelengths greater than 100 nanometers to less than 400 nanometers while minimizing and/or eliminating exposure of the low k dielectric material to activating energy other than the ultraviolet radiation exposure. As used herein, the term “activating energy” generally refers to an energy source that affects the molecular bonding network of the dielectric material. For example, activating energy sources as referred to herein can include, but are not limited to, thermal energy sources such as may occur upon exposure of the dielectric material to hot plates, annealing furnaces, and the like; proton and electron energy sources such as may occur upon exposure of the dielectric material to photons and/or electrons during plasma mediated processes; and the like.

As will be described in greater detail below, it has unexpectedly been found that exposure of the low k dielectric material to activating energy decreases the efficiency of the UV cure process. While not wanting to be bound by theory, it is believed that the activating energy, either via activation of a catalyst, if present, or otherwise, changes the molecular bonding network arrangement, and may freeze the modified network structure, such that the subsequent UV curing process does not effectively crosslink the dielectric material (e.g., form Si—O bonds for silsequioxane based dielectric materials). As a result, the mobility within the low k material is strongly reduced and the subsequent curing with maximum hardness and modulus properties of the low k dielectric material cannot be obtained. By eliminating and/or minimizing exposure to any activating energy subsequent to deposition of the low k dielectric material but prior to exposure to ultraviolet radiation, it has unexpectedly been found that the mechanical properties of the dielectric material are enhanced relative to uncured dielectric materials or relative to dielectric materials exposed to significant amounts of activating energy prior to the ultraviolet radiation exposure. Advantageously, the UV curing process does not deleteriously affect the dielectric constant of the low k dielectric material.

In terms of minimizing exposure to activating energy, it is desirable to minimize exposure to any source of activating energy that may be included to form the film containing the dielectric material. For example, spin-on dielectric materials are generally solvent based. Once coated onto the substrate, the coated dielectric materials is generally subject to a multiple stepped hotplate bake process recipe to remove the solvent and set the film. These hotplate bake process recipes are generally tailored to the specific type of dielectric material and typically include a stepwise increase of temperatures for defined periods of time. By way of example, a common hotplate bake recipe for a methylsilsesquioxane (MSQ) spin-on low k dielectric material can include heating the coated film at 100° C. for 1 minute, then heating the coated film at 150° C. for a period of 1 minute, and then heating the coated film at 200° C. for a period of 1 minute. In the prior art, it was only after exposure to these stepped heating temperatures the coating then was exposed to ultraviolet radiation. Applicants have discovered that the additional heating steps can affect the crosslinking efficiency of the ultraviolet radiation exposure. Minimizing and/or eliminating exposure to the activating energy increases the crosslinking efficiency associated with the ultraviolet radiation exposure. In the example given, instead of exposure to the stepped temperatures, it has been found that if exposure is minimized such as to less than the three steps or less than the one minute duration for each step noted in the example above, the crosslinking efficiency from exposure to the ultraviolet radiation pattern is increased. For example, after spin coating the MSQ dielectric material, the material can be heated to 100° C. for 1 minute (or other desired temperature and time) prior to exposure to the ultraviolet radiation, which can be sufficient to form a stable coating with minimal residual solvent. The stabilized coating can then be effectively crosslinked with the ultraviolet radiation so as to maximize the mechanical properties without deleteriously affecting the dielectric constant. With some low k dielectric materials, the dielectric constant advantageously decreases upon exposure to the ultraviolet radiation pattern.

In one embodiment, the efficiency of the UV curing process is improved by minimizing the exposure to thermal activation energy (time and/or temperature) prior to exposure to UV radiation. In another embodiment, the efficiency of the UV curing process is improved by minimizing activation of any catalyst or chemical reactant that may be present in the low k material prior to exposure to UV radiation. In yet another embodiment, the efficiency of the UV curing process is improved by minimizing the exposure of the low k material to activation energy, which may be provided by means of thermal or other energy sources, including but not limited to high multi-temperature baking, a furnace curing, an anneal curing, plasma exposure, electron beam exposure, or chemical exposure.

The beneficial results of the disclosed process are independent of the manner in which the low k dielectric material is deposited. For example, the low k dielectric material can be spin-coated, deposited by chemical vapor deposition (CVD), or the like

Likewise, the process is generally independent of the class of low k dielectric material employed. Suitable classes of low k dielectric materials include, but are not intended to be limited to, commonly used spin-on low k materials and CVD deposited low k materials. These low k materials can be organic materials, inorganic materials, or combinations thereof. More particularly, suitable low k dielectric materials can include hydrogen silsesquioxane (HSQ), alkyl silsesquioxane dielectric materials such as MSQ, carbon doped oxide (CDO) dielectric materials, fluorosilicate glasses, diamond-like carbon, parylene, hydrogenated silicon oxy-carbide (SiCOH) dielectric materials, B-staged polymers such as benzocyclobutene (BCB) dielectric materials, arylcyclobutene-based dielectric materials, polyphenylene-based dielectric materials, polyarylene ethers, polyimides, fluorinated polyimides, porous silicas, silica zeolites, porous derivatives of the above noted dielectric materials, and combinations thereof. The porous derivatives, i.e., mesoporous or nanoporous, can have porogen-generated pores, solvent-formed pores, or molecular engineered pores, which may be interconnected or closed, and which may be distributed, random, or ordered, such as vertically oriented pores.

As previously discussed herein, the low k dielectric material may or may not comprise a catalyst or other chemical reactant, which may be provided for enhancing network bonding arrangements within the low k material. As such, special attention should be given towards low k materials based on silica zeolites. This relatively new class of low k materials or silica zeolite films, e.g. NCS from Catalysis & Chemicals Ind. Co. (CCIC), Japan are deposited by spin-coating a material comprising a silica source and a catalyst (also referred to as commander or zeolite forming structure directing agent) present in an appropriate solvent onto a substrate. U.S. Pat. No. 6,573,131 describes the formation of said silica zeolite low k dielectric thin films and use as a dielectric material in semiconductor devices. As taught in this patent, the formation of the zeolite low k material comprises several heating steps performed after the deposition process. These heating steps, also referred to as calcinations, generally include heating at temperatures of from about 350° to 550° C. Other prior art references apply a three-step bake process followed by a furnace or UV cure. The three-step bake process involves a first step at 150° C., a second step at 250° C. and finally a third step a 350° C. Applicants have discovered that once the zeolite low k material is subjected to the above described heating processes/sequences, there is no catalyst left in the material and the zeolite (or structuring) is irreversible. Further cross-linking of the low k material by exposure to UV-cure after the bake process will not yield significant improvement towards hardness property, elastic modulus property or k-value. The process for formation of these zeolite low k materials according to the present disclosure comprises a bake step with limited temperature (most preferred below 150° C.) and limited exposure time prior to the UV cure process, which removes most of the solvent but keeps most of the catalyst present in the low k film. The presence of the catalyst during the subsequent UV cure process resulted in an improved structuring (also referred to as cross-linking efficiency) leading to enhanced mechanical properties, enhanced hardness properties and enhanced elastic modulus properties.

For spin coat applications, the monomers, monomer mixtures, and/or polymers that define the low k dielectric material can be, and in many ways are designed to be solvated or dissolved in any suitable solvent, so long as the resulting solutions can be spin coated or otherwise mechanically layered onto a substrate, a wafer, or a layered material. There are numerous methods of spin coating a dielectric material known in the art, and all of the known methods are considered appropriate.

Preferred solutions are designed and contemplated to be spin coated, rolled, dripped or sprayed onto a wafer, a substrate or layered material. Most preferred solutions are designed to be spin coated onto a wafer, a substrate or layered material. Typical solvents are those solvents that are readily available to those in the field of dielectric materials, layered components, or electronic components. Contemplated solvents include any suitable pure or mixture of organic, organometallic or inorganic molecules that are volatilized at a desired temperature. The solvent may also comprise any suitable pure or mixture of polar and non-polar compounds. In preferred embodiments, the solvent comprises water, ethanol, propanol, acetone, toluene, ethers, cyclohexanone, butyrolactone, methylethylketone, methylisobutylketone, N-methylpyrrolidone, polyethyleneglycolmethylether, mesitylene, and anisole.

Still further, the UV process described herein is generally independent of the type of substrate employed. Suitable substrates for coating the dielectric material may comprise any desirable substantially solid material. Particularly desirable substrate layers would comprise films, glass, ceramic, plastic, metal or coated metal, or composite material. In some embodiments, the substrate comprises a silicon or gallium arsenide die or wafer surface, a packaging surface such as found in a copper, silver, nickel or gold plated leadframe, a copper surface such as found in a circuit board or package interconnect trace, a via-wall or stiffener interface (“copper” includes considerations of bare copper and it's oxides), a polymer-based packaging or board interface such as found in a polyimide-based flex package, lead or other metal alloy solder ball surface, glass and polymers. In other embodiments, the substrate comprises a material common in the packaging and circuit board industries such as silicon, copper, glass, and polymers.

As noted above, it has been found that curing the low k dielectric material with the ultraviolet radiation while minimizing or avoiding prior exposure to activation energy during the bake step provides improved properties relative to furnace annealed low k materials or materials exposed to excessive amounts of activating energy. Activating energy may be provided via thermal or other energy sources, including but not limited to high multi-temperature baking, a furnace curing, an anneal curing, plasma exposure, electron beam exposure, or chemical exposure. In particular, the elastic modulus properties and mechanical hardness properties have been found to increase as a function of the UV irradiation, without deleteriously changing the dielectric constant of the low k material. Still further, the UV cure process can reduce the total thermal budget as compared to the furnace annealed curing processes.

In order to raise the elastic modulus and/or material hardness of the low k dielectric material, Applicants expose the low k dielectric material to ultraviolet radiation for a period of time and intensity effective to increase the elastic modulus and/or material hardness without increasing the dielectric constant. By eliminating and/or minimizing prior exposure to activating energy, the effectiveness of the UV curing process unexpectedly improves. It has also been found that the UV curing process also improves the chemical stability, e.g., wet etching resistance. Moreover, for some materials, the dielectric constant decreases as a function of the ultraviolet radiation exposure.

In one embodiment, the process comprises forming a stable film of the low k dielectric material by any means, wherein the so-formed low k dielectric material has a first dielectric constant, a first elastic modulus, and a first material hardness. The low k dielectric material is then cured by exposure to a ultraviolet radiation pattern to produce the UV cured dielectric material having a second dielectric constant which is comparable to the first dielectric constant, a second elastic modulus which is greater than the first elastic modulus and/or a second material hardness which is greater than the first material hardness. By “comparable to”, we mean within about ±20% of the first dielectric constant. In one embodiment, the dielectric constant advantageously decreases as a result of the UV cure process. The increases in the second elastic modulus and/or material hardness properties are significantly improved.

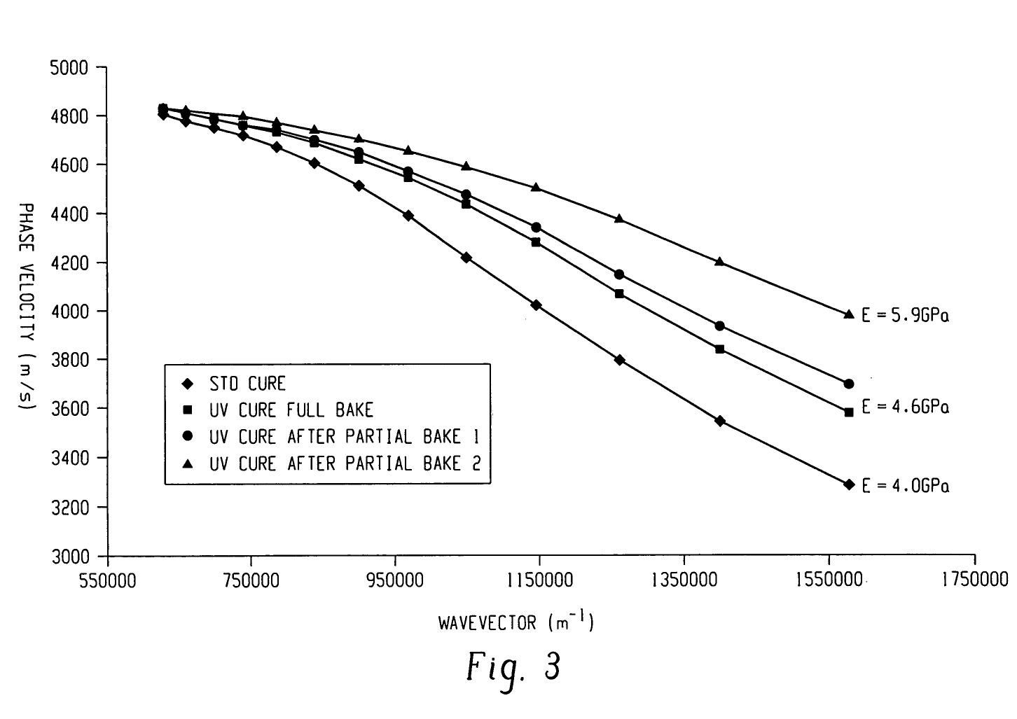

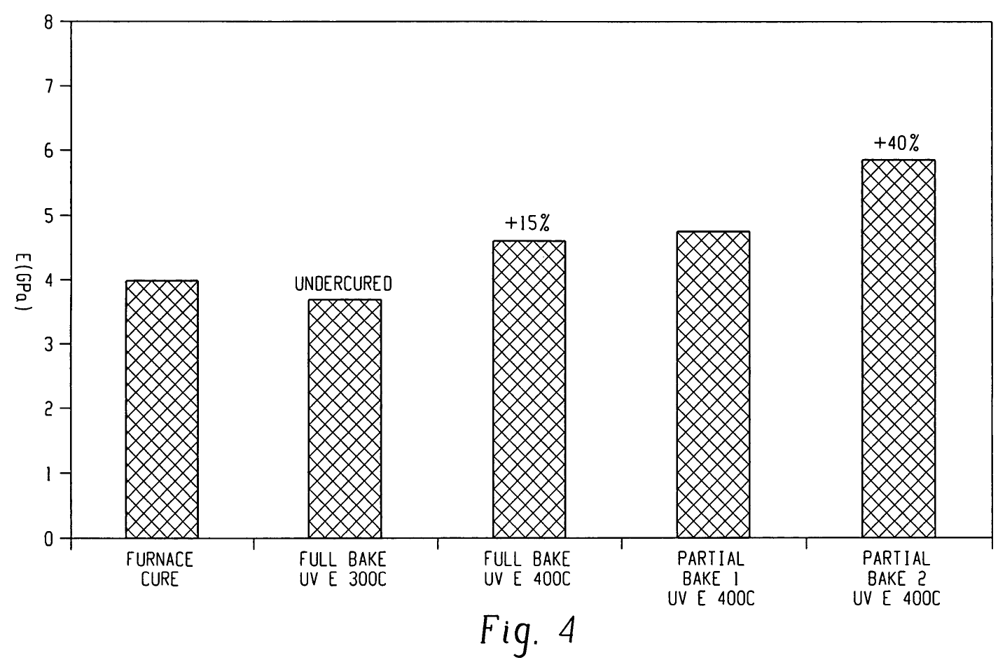

The elastic modulus and/or material hardness of the UV cured dielectric materials are increased compared to the same materials that are furnace (thermally) cured or uncured dielectric materials or exposed to excessive amounts of activating energy. A furnace cured or uncured low k dielectric material typically has an elastic modulus between about 0.5 GPa and about 8 GPa when the dielectric constant is between about 1.6 and about 2.7. In contrast, the elastic modulus of the UV cured dielectric material is greater than or about 2.5 GPa, and more typically between about 4 GPa and about 12 GPa. The material hardness of the furnace cured or the uncured film is about 0.1 GPa. In contrast, the material hardness of the UV cured dielectric material is greater than or about 0.25 GPa, and more typically between about 0.25 GPa and about 1.2 GPa. FIGS. 3 and 4 graphically illustrate the value for the elastic modulus obtained for a NCS low k material after respectively a furnace cure, a conventional UV cure performed after a full bake sequence, a UV cure performed after a partial bake sequence (comprising a first bake step at 150° C. and a second bake step at 250° C.) and a UV cure performed after a partial bake (comprising a single bake step at 150° C.). The resulting elastic modulus after conventional furnace cure is 4.0 GPa. The elastic modulus after UV cure with prior full bake sequence is 4.6 GPa and after an optimized partial bake (comprising a single bake step at 150° C.) 5.9 GPa, which is an improvement of about 40% or more.

In addition to the modulus and hardness properties beneficially increasing without deleteriously increasing dielectric constant, the UV curing process can be used to improve wet etch resistance, the resulting UV cured dielectric materials also have improved chemical stability and improved dimensional stability. By improved “chemical stability”, we mean that the UV cured dielectric materials are more resistant to chemicals, such as cleaning solutions and chemical polishing solutions as well as plasma damage such as may occur during plasma mediated ashing and etching processes.

For example, after lithography, a wet etching process may be employed to selectively remove portions of the substrate that includes a layer of the low k dielectric material. Typically, the substrate is immersed into a stripper such as a dilute aqueous hydrofluoric acid bath. Other wet strippers include acids, bases, and solvents as are known to those skilled in the art. The particular wet strippers used are well within the skill of those in the art. For example, nitric acid, sulfuric acid, ammonia, hydrofluoric acid are commonly employed as wet strippers. In operation, the wet stripper is immersed, puddled, streamed, sprayed, or the like onto the substrate and subsequently rinsed with deionized water. As will be demonstrated in the examples discussed in greater detail below, the UV cured low k dielectric material has improved wet etch resistance relative to the same material that was not exposed to the UV cure process.

In the UV curing process, a UV radiator tool can be utilized. A suitable UV radiator tool is the RapidCure™ tool commercially available from Axcelis Technologies, Incorporated. During use, the light source chamber can be first purged with an inert gas such as nitrogen, helium, or argon to allow the UV radiation to enter an adjacent process chamber with minimal spectral absorption. The substrate containing the stable dielectric material is positioned with in the process chamber, which is purged separately with process gases, such as nitrogen, hydrogen, argon, helium, neon water vapor, CO_{z}, O_{z}, CₓH_{y}, CₓFy, CₓH_{z}F_{y}, and mixtures thereof, wherein x is an integer between 1 and 6, y is an integer between 4 and 14, and z is an integer between I and 3, may be utilized for different applications. In this regard, UV curing can occur at vacuum conditions, or at conditions without the presence of oxygen or oxidizing gases. By the term “stable”, it is generally defined as the minimal amount of activating energy needed to form a layer of the dielectric material on the substrate. As such, the film should exhibit good adhesion, among others.

In one embodiment, the process chamber is purged with a hydrogen and helium gas mixture. UV generating bulbs with different spectral distributions may be selected depending on the application. The UV light source can be microwave driven, arc discharge, dielectric barrier discharge, electron impact generated or the like. During the UV exposure, the temperature of the substrate may be controlled to about room temperature to about 450° C., optionally by an infrared light source, an optical light source, a hot surface, or the UV light source itself. The process pressure can be less than, greater than, or about equal to atmospheric pressure. The UV power is about 0.1 to about 2,000 mW/cm² with an exposure time less than 300 seconds, for example.

The low k dielectric material is exposed to ultraviolet radiation for no more than or about 300 seconds and, more particularly, between about 60 and about 180 seconds. Also, UV treating can be performed at a temperature between about room temperature and about 450° C.; at a process pressure that is less than, greater than, or about equal to atmospheric pressure; at a UV power between about 0.1 and about 2000 mW/cm²; and a UV wavelength spectrum between about 100 and about 400 nm. Moreover, the UV cured dielectric material can be UV treated with a process gas purge, such as N₂, O_{z}, Ar, He, H₂, H₂O vapor, CO_{z}, CₓH_{y}, CₓF_{y}, CₓH_{z}F_{y}, air, and combinations thereof, wherein x is an integer between 1 and 6, y is an integer between 4 and 14, and z is an integer between 1 and 3.

Another type of post-UV treatment that can be used involves the exposure of the UV cured dielectric materials to a plasma condition at elevated temperatures. In a typical plasma-assisted post-UV treatment, process gases, such as O₂, N₂, H₂, Ar, He, CₓH_{y}, fluorine-containing gas, and mixtures thereof, wherein x is an integer between 1 and 6, and y is an integer between 4 and 14, may be utilized for different applications. The wafer temperature may be controlled ranging from about room temperature to about 450° C. Typically, the UV cured dielectric material is plasma treated at a process pressure between about 1 Torr and about 10 Torr.

Examples of typical plasma-assisted post-UV treatment conditions for 200 mm and 300 mm wafers are shown in Table 1 below.

TABLE 1

| Condition | 200 mm system | 300 mm system |
|---|---|---|
| Microwave Plasma Power: | 500 W-3000 W | 500 W-3000 W |
| Wafer Temperature: | 80° C.-350° C. | 80° C.-350° C. |
| Process Pressure: | 1.0 Torr-3.0 Torr | 1.0 Torr-4.0 Torr |
| Plasma Treatment Time: | < 90 seconds | < 90 seconds |
| Process Gases: | H₂/N₂/CF₄/O₂/Ar/He/CₓH_{y} | H₂/N₂/CF₄/O₂/Ar/He/CₓH_{y} |

| | | | | |
|---|---|---|---|---|
| N₂H₂ Flow Rate: | >0-4000 | sccm | >0-10,000 | sccm |
| O₂ Flow Rate: | >0-4000 | sccm | >0-10,000 | sccm |
| CF₄ Flow Rate: | >0-400 | sccm | >0-1000 | sccm |
| Ar Flow Rate: | >0-4000 | sccm | >0-10,000 | sccm |
| He Flow Rate: | >0-4000 | sccm | >0-10,000 | sccm |

Optionally, a thermal cure may be employed subsequent to ultraviolet radiation exposure of the low k dielectric material. For example, the UV cured pre-metal dielectric materials can be subject to a furnace cure (e.g., 400° C., N₂ ambient for 30 minutes) or a hot plate final cure step (e.g., 420° C. to 460° C. for 3 to 5 minutes), without affecting the improved mechanical properties provided by the ultraviolet radiation exposure.

In another embodiment, a second UV treatment of the previously UV cured low k material is employed using different wavelengths, which can produce a material having a lower dielectric constant, and of equal or further improved elastic modulus and material hardness.

Typical material properties of porous low k films with UV curing are shown in Table 2 below.

TABLE 2

| | MSQ-Based Porous | HSQ-Based Porous |
|---|---|---|
| Material Properties | Dielectric Material (%) | Dielectric Material (%) |
| Change in Dielectric Constant | <0.1 | <0.2 |
| Modulus Increase | ≧50% | ≧50% |
| Porosity | Unchanged | Unchanged |
| Compatible UV Curing | Vacuum, Ar, He, Ne, H₂, | Vacuum, N₂/H₂, Ar, He, |
| Process gases | NH₃, CO₂, CO, N₂/H₂ | Ne, NH₃, O₂, H₂, H₂O |
| Density | Unchanged | Unchanged |
| Thickness Loss | <10% | <10% |
| Refractive Index Change | <0.01 | <0.03 |

The disclosure is further illustrated by the following non-limiting examples.

### EXAMPLE 1

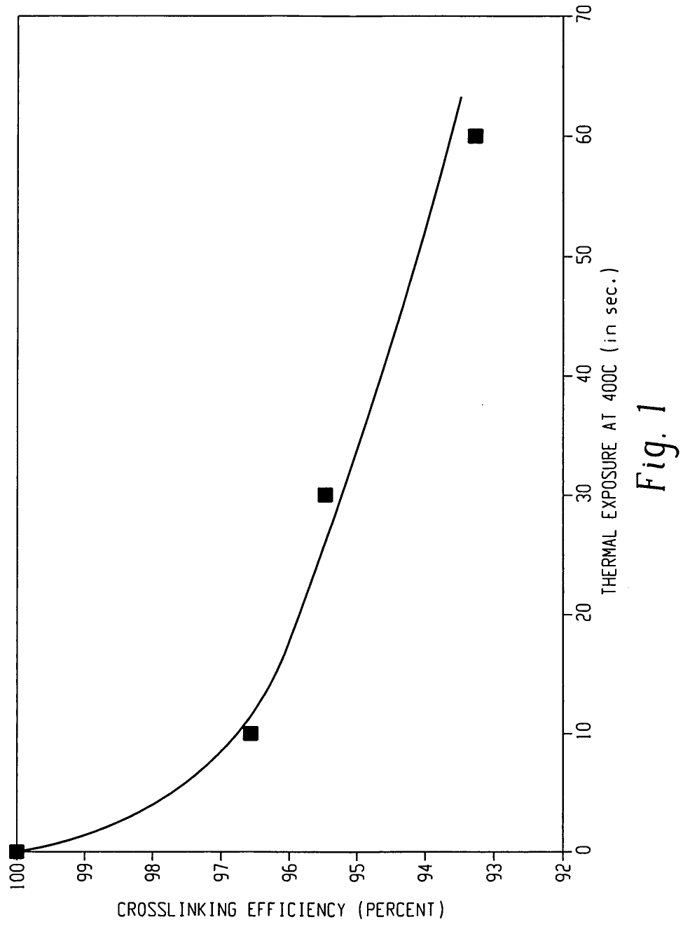

In this example, JSR's LKD5537 p-MSQ low k films have been tested for their impact of increasing amount of heat exposure prior to submitting it to the UV cure treatment. 200 mm wafers have been used in the Axcelis RapidCure™ 320fc UV cure tool. FIG. 1 graphically illustrates crosslinking efficiency as a function of thermal exposure for the p-MSQ film, wherein the thermal exposure was prior to ultraviolet exposure, which further supports and shows the effect of exposure to activating energy prior to ultraviolet radiation exposure.

### EXAMPLE 2

In this example, a SiCOH low k dielectric material, available under the trademark BLACK DIAMOND was deposited by CVD and obtained from Applied Materials. Wafers containing the SiCOH low k material were crosslinked by exposure to ultraviolet radiation. A portion of the wafers was exposed to activating energy in the form a plasma treatment prior to exposure to the ultraviolet radiation. The hardness and modulus properties were measured using standard techniques, the results of which are illustrated in Table 3 below.

TABLE 3

| | | CVD Deposited and |
|---|---|---|
| | CVD Deposited | Plasma Treatment |
| Film Hardness (Gpa) | 1.8 | 1.9 |
| Hardness after UV Cure | 2.5 | 2.3 |
| Increase with UV (%) | 40 | 20 |
| Young's modulus (Gpa) | 11 | 12 |
| Modulus after UV cure (GPa) | 16 | 14.5 |
| Increase with UV (%) | 45 | 20 |

The results clearly show increased mechanical properties relative to the dielectric material exposed to activating energy in the form of the plasma treatment. Moreover, film thickness measurements and FTIR analysis clearly indicate that a plasma treated low k film has limited ability to be cross-linked during the UV cure process, in contrast to the as deposited low k film.

### EXAMPLE 3

In this example, wafers containing a NCS low k dielectric material were obtained from CCIC and evaluated. The wafers were exposed to a 150° C. for 1 minute hotplate bake to stabilize the film. A portion of the wafers was then exposed to the ultraviolet radiation pattern as in Example 1. The remaining wafers were exposed to additional heat treatments as recommended by the manufacturer, which included additional heating of the wafers at 250° C. for 1 minute followed by additional heating at 350° C. for 1 minute. After the stepped heating sequence was completed, the wafers were exposed to ultraviolet radiation. The ultraviolet radiation intensity and duration were the same for all processed wafers. The hot plate bake was performed on a spin-track film deposition system, while the pre-heat step was performed in a UV cure chamber by placing the wafer on a heated chuck for a certain amount of time without turning on the UV light. The results are shown in Table 4.

The results clearly show a significant difference in the final Young's modulus. In addition, there is a difference in the FTIR signature of the films that depend on the presence or absence of the activating energy. Eliminating the hotplate bake and pre-heat step significantly increases the ability of the low k dielectric material to be cross-linked under UV. The following Table 4 summarizes the measurement results of this comparison.

TABLE 4

| | | 150° C., 250° C., |
|---|---|---|
| | 150° C. bake only | and 350° C. |
| Film Shrinkage (%) | 10 | 5 |
| Young's Modulus | 40 | 20 |
| Increase (%) | | |

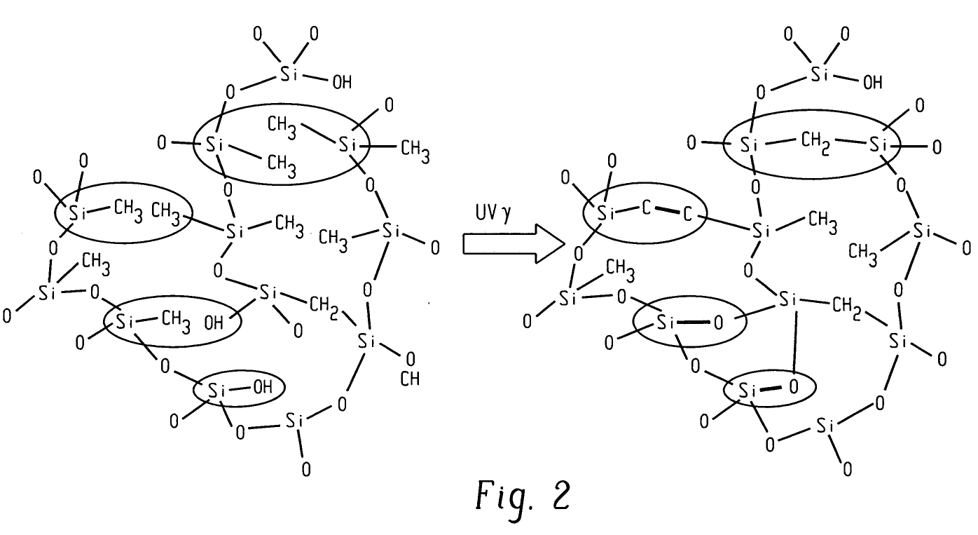

FIG. 2 illustrates the network of a NCS material before and after the UV-cure process.

FIG. 3 graphically illustrates the phase velocity as a function of the wave vector for the NCS low k material after respectively a furnace cure, a conventional UV cure performed after a full bake sequence, a UV cure performed after a partial bake sequence (comprising a first bake step at 150° C. and a second bake step at 250° C.) and a UV cure performed after a partial bake (comprising one step at 150° C.). The resulting elastic modulus after conventional furnace cure is 4.0 GPa. The elastic modulus after UV cure with prior full bake sequence is 4.6 GPa and after an optimized partial bake (comprising one step at 150° C.) 5.9 GPA which is an improvement of 40%.

FIG. 4 graphically illustrates the elastic modulus of the NCS low k material after respectively a furnace cure, a conventional UV cure performed after a full bake sequence, a UV cure performed after a partial bake sequence (comprising a first bake step at 150° C. and a second bake step at 250° C.) and a UV cure performed after a partial bake (comprising a single bake step at 150° C.).

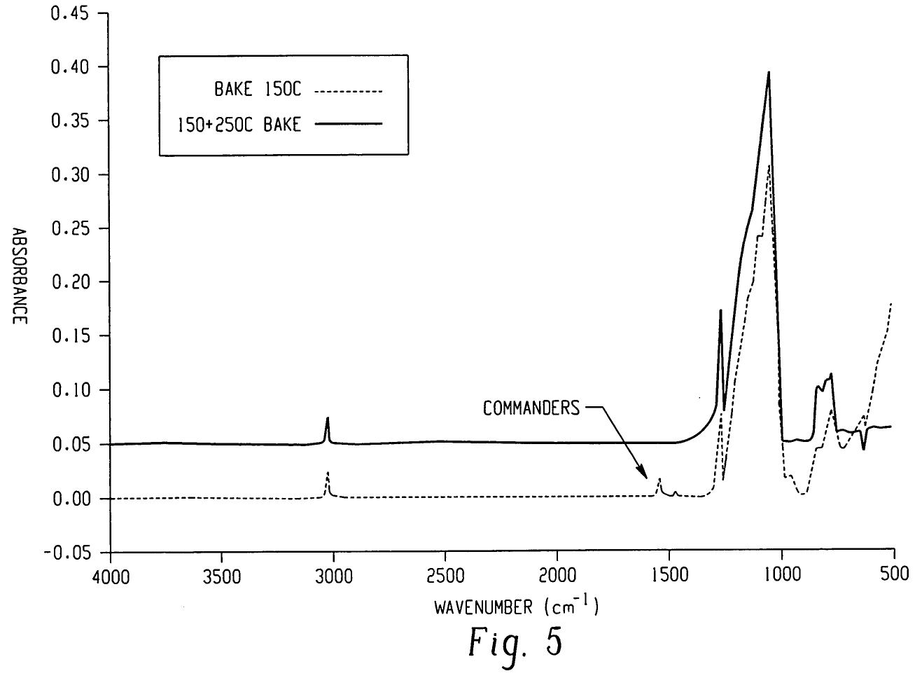

FIG. 5 shows the FTIR spectrum of the NCS low k material after a partial bake process comprising a first step at 150° C. and a second step at 250° C. and the FTIR spectrum of the same NCS low k material after a partial bake process comprising a single heating step at about 150° C. The spectrum shows clearly that there is still catalyst present after the partial bake process.

### EXAMPLE 4

In another example so-called Nanoglass E low k dielectric material available from Honeywell Corporation is both furnace cured film and UV cured film. The k-value is comparable, but the modulus is increased by more than 50%, as can be seen in Table 5.

TABLE 5

| | | Furnace cured | UV Cured |
|---|---|---|---|
| | | NANOGLASS ®E | NANOGLASS ®E |
| Properties | Method | (425° C./3 min) | (4250C/60 min) |
| Film Thickness Range | Ellipsometer | 100-800 nm | 100-800 nm |
| Refractive Index | Ellipsometer | 1.22 | 1.24 |
| Dielectric Constant | Hg Probe | 2.25 | 2.20 |
| | (600 nm film) | | |
| Leakage Current | Hg Probe | 1.24E-8 | 6.55E-9 |
| @ 2 MV/cm (A/cm2) | (600 nm film) | | |
| Breakdown Strength | Hg Probe | 4.34 | 4.78 |
| (MV/cm) | (600 nm film) | | |
| Modulus (GPa) | Nano- | 4.0 | 6.5 |
| | indentation | | |
| | (600 nm film) | | |
| Hardness (GPa) | Nano- | 0.5 | 0.73 |
| | indentation | | |
| | (600 nm film) | | |

While the disclosure has been described with reference to an exemplary embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment disclosed as the best mode contemplated for carrying out this disclosure, but that the disclosure will include all embodiments falling within the scope of the appended claims.

1. A process for forming a low k dielectric material coated onto a surface of a substrate, comprising:
depositing the low k dielectric material onto the surface, wherein the low k material comprises a catalyst and/or chemical reactant and; and
exposing the low k dielectric material to ultraviolet radiation for a period of time and intensity effective to increase a mechanical property of the low k dielectric material, wherein the mechanical property increases relative to a corresponding mechanical property of the low k dielectric material free from exposure to the ultraviolet radiation, or the corresponding mechanical property of the low k dielectric material that is furnace cured, or the corresponding mechanical property of the low k dielectric material that is exposed to excessive activating energy prior to ultraviolet radiation exposure.

2. The process of claim 1, wherein excessive activating energy originates from a high multi-temperature bake process, a furnace cure, an annealing cure, a plasma exposure, electron beam exposure, chemical exposure or a multi-temperature cure process prior to the ultraviolet radiation

3. The process of claim 1, wherein depositing the low k dielectric material comprises spin coating a solution containing the low k dielectric material.

4. The process of claim 1, wherein depositing the low k material comprises chemical vapor deposition.

5. The process of claim 1, wherein the activation energy exposure is minimized such that the catalyst and/or chemical reactant remains active prior to ultraviolet radiation exposure.

6. The process of claim 5, wherein the catalyst and/or chemical reactant is introduced subsequent to exposure of the low k dielectric to any activation energy, but prior to, or simultaneously with, exposure of the low k material to the ultraviolet radiation.

7. The process of claim 1, wherein the ultraviolet radiation pattern comprises wavelengths greater than 100 nanometers to less than 400 nanometers.

8. The process of claim 1, further comprising heating the substrate during and/or subsequent to exposing the low k dielectric material to the ultraviolet radiation.

9. The process of claim 1, wherein the low k dielectric material comprises hydrogen silsesquioxane, alkyl silsesquioxanes, carbon doped oxides, fluorosilicate glasses, diamond-like carbons, parylenes, hydrogenated silicon oxy-carbides, B-staged polymers, arylcyclobutene-based materials, polyphenylene-based materials, polyarylene ethers, polyimides, fluorinated polyimides, porous silicas, silica zeolites and combinations comprising at least one of the foregoing.

10. The process of claim 1, wherein the low k dielectric material has substantially the same dielectric constant before and after exposure to the ultraviolet radiation.

11. The process of claim 1, wherein exposing the low k dielectric material to the ultraviolet radiation decreases the dielectric constant.

12. The process of claim 1, wherein the mechanical property comprises an elastic modulus property, a hardness property, or a combination thereof.

13. The process of claim 1, wherein the elastic modulus property, and/or a hardness property increases by at least 40% relative to a corresponding elastic modulus property, and/or a hardness property of the low k dielectric material free from exposure to the ultraviolet radiation, or the corresponding mechanical property of the low k dielectric material that is furnace cured, or the corresponding mechanical property of the low k dielectric material that is exposed to excessive activating energy prior to ultraviolet radiation exposure.

14. The process of claim 1, wherein the elastic modulus property, and/or a hardness property increases by at least 50% relative to a corresponding elastic modulus property, and/or a hardness property of the low k dielectric material free from exposure to the ultraviolet radiation, or the corresponding mechanical property of the low k dielectric material that is furnace cured, or the corresponding mechanical property of the low k dielectric material that is exposed to excessive activating energy prior to ultraviolet radiation exposure.

15. A process for forming a low k dielectric material coated onto a surface of a substrate, comprising:
depositing the low k dielectric material onto the surface wherein the low k material comprises a catalyst and/or chemical reactant and; and
exposing the low k dielectric material to ultraviolet radiation, wherein the steps of depositing and exposing are effective to provide a crosslinking efficiency greater than 97% and form the low k dielectric material.

16. The process of claim 15, wherein the dielectric material has a dielectric constant less than 3.0.

17. The process of claim 15, wherein depositing the low k material comprises spin coating a solution containing the low k dielectric material.

18. The process of claim 15, wherein depositing the low k material comprises chemical vapor deposition.

19. The process of claim 15, further comprising heating the substrate during and/or subsequent to exposing the low k dielectric material to the ultraviolet radiation.

20. The process of claim 15, wherein the low k dielectric material comprises hydrogen silsesquioxane, alkyl silsesquioxanes, carbon doped oxides, fluorosilicate glasses, diamond-like carbons, parylenes, hydrogenated silicon oxy-carbides, B-staged polymers, arylcyclobutene-based materials, polyphenylene-based materials, polyarylene ethers, polyimides, fluorinated polyimides, porous silicas, silica zeolites and combinations comprising at least one of the foregoing.

21. The process of claim 15, wherein the low k dielectric material has substantially the same dielectric constant before and after exposure to the ultraviolet radiation.

22. The process of claim 15, exposing the low k dielectric material to ultraviolet radiation increases an elastic modulus property, a hardness property, or a combination thereof relative to the low k dielectric material free of exposure to ultraviolet radiation.

23. The process of claim 15, wherein the steps of depositing and exposing are effective to maintain activity of the catalyst and/or the chemical reactant during the step of exposing the low k dielectric to the ultraviolet radiation.

24. A process for forming a low k dielectric material coated onto a surface of a substrate, comprising:
depositing the low k dielectric material onto the surface, wherein the low k material comprises a catalyst and/or chemical reactant; and
exposing the low k dielectric material to ultraviolet radiation for a period of time and intensity effective to increase a elastic modulus property of the low k dielectric material, wherein the elastic modulus property is significantly improved compared to a corresponding elastic modulus property of the low k dielectric material free from exposure to the ultraviolet radiation, or the corresponding elastic modulus property of the low k dielectric material that is furnace cured, or the corresponding elastic modulus property of the low k dielectric material that is exposed to excessive activating energy prior to ultraviolet radiation exposure, wherein excessive activating energy comprises a furnace cure, an annealing cure, or a multi-temperature cure process prior to the ultraviolet radiation.

25. The process of claim 24, wherein the low k dielectric material comprises hydrogen silsesquioxane, alkyl silsesquioxanes, carbon doped oxides, fluorosilicate glasses, diamond-like carbons, parylenes, hydrogenated silicon oxy-carbides, B-staged polymers, arylcyclobutene-based materials, polyphenylene-based materials, polyarylene ethers, polyimides, fluorinated polyimides, porous silicas, silica zeolites and combinations comprising at least one of the foregoing.

26. The process of claim 24, wherein the low k dielectric material has substantially the same dielectric constant before and after exposure to the ultraviolet radiation.

27. A process for forming a low k dielectric material coated onto a surface of a substrate, comprising:
depositing the low k dielectric material onto the surface, wherein the low k material comprises a catalyst and/or chemical reactant; and
exposing the low k dielectric material to ultraviolet radiation for a period of time and intensity effective to increase a hardness property of the low k dielectric material, wherein the hardness property is significantly improved compared to a corresponding hardness property of the low k dielectric material free from exposure to the ultraviolet radiation, or the corresponding hardness property of the low k dielectric material that is furnace cured, or the corresponding hardness property of the low k dielectric material that is exposed to excessive activating energy prior to ultraviolet radiation exposure, wherein excessive activating energy comprises a furnace cure, an annealing cure, or a multi-temperature cure process prior to the ultraviolet radiation.

28. The process of claim 27, wherein the low k dielectric material comprises hydrogen silsesquioxane, alkyl silsesquioxanes, carbon doped oxides, fluorosilicate glasses, diamond-like carbons, parylenes, hydrogenated silicon oxy-carbides, B-staged polymers, arylcyclobutene-based materials, polyphenylene-based materials, polyarylene ethers, polyimides, fluorinated polyimides, porous silicas, silica zeolites and combinations comprising at least one of the foregoing.

29. The process of claim 27, wherein the low k dielectric material has substantially the same dielectric constant before and after exposure to the ultraviolet radiation.

30. A process for forming a cured low k dielectric material coated on a substrate, comprising:
depositing the low k dielectric material onto the surface, wherein the low k material comprises a catalyst and/or chemical reactant;
avoiding exposure of the low k dielectric material to excessive activating energy from a furnace cure, an annealing cure, or a multi-temperature cure process; and
exposing the low k dielectric material to ultraviolet radiation for a period of time and intensity effective to cure the low k dielectric material.

31. A process for forming a silica zeolite low k dielectric material, comprising:
depositing the silica zeolite low k dielectric material onto a substrate, wherein the silica zeolite low k dielectric material comprises a catalyst;
baking the silica zeolite low k dielectric material at a bake temperature and time effective to maintain an activity of the catalyst; and
exposing the silica zeolite low k dielectric material to ultraviolet radiation for a time and intensity effective to structure the silica zeolite low k dielectric material and render the catalyst inactive.

32. The process of claim 31, wherein the bake temperature is less than or equal to 150° C.

33. The process of claim 31, wherein baking the silica zeolite low k dielectric material comprises exposing the silica zeolite low k dielectric material to the bake temperature and time in a single step.
